(19) United States
(12) Patent Application Publication
(10) Pub. No.: US 2003/0223247 A1
(43) Pub. Date: Dec. 4, 2003

(54) Illumination device

(75) Inventor: Steven Karras, Verona, NJ (US)

Correspondence Address: William Squire, Esq., c/o Carella, Byrne Bain, Gilfillan,, Cecchi, Stewart & Olstein, 6 Becker Farm Road, Roseland, NJ, 07068, US

(73) Assignee: SAK Technologies, Inc.

(21) Appl. No.: 10/156,881

(22) Filed: May 29, 2002

(51) Int. Cl. F21V 8/00; F21V 7/04

(52) U.S. Cl. 362/555; 362/551; 362/558; 362/235; 362/31

(57) ABSTRACT

An illumination device comprises a housing having two mating halves which mount an acrylic rod-like lens forming an optical illumination transmitting element in a window thereof. The optical illumination transmitting element is half round with a light scattering reflector bonded to a flat side of the element. Multiple LEDs of any selected color and of selected brightness are inserted in bores in the optical illumination transmitting element at opposite ends thereof. The LEDs are powered by a 9 volt battery via a Schmitt trigger circuit. The circuit is switched to provide steady state illumination or on-off flashing illumination. The housing is elongated in the shape of a wand and includes straps which attach the device to scooters, bicycles, automotive appendages, boating appendages, and many other arrangements for use as warning safety lights, and decorative or mood lighting. The optical illumination transmitting element transmits unfocussed light in a variety of directions and is readily visible for safety purposes on individuals or vehicles and so on or other uses.

This invention relates to illumination arrangements for use as a safety or decorative lighting.

There are many needs for illumination devices in the field of safety and decoration. However, typically unique devices have been devised for each application. For example, roadside warning devices typically comprise lights coupled to automotive systems for providing illumination for emergency repair, roadside warning lamps, flashlight type devices which may include colored lens for warning and safety purposes and so on.

Other differently configured arrangements are provided pedestrians during walking or jogging at night. Mostly, however, pedestrians use reflectors rather than illuminators which tend to be either too bulky for such use or too low an intensity to be useful. Steady state and flashing light devices also are provided, but in many diverse different configurations.

Traffic officers also use illumination devices which differ from the above devices in still different configurations.

Further, objects carried in vehicles sometimes may be too large for the trunk and a need is seen for providing an illumination device for such objects. Present illumination devices may or may not be readily adapted for such use depending upon the object configuration. Many other special applications for illumination devices are in need of practical convenient devices which are not always commercially available such as children scooters and bicycles, automotive hood, trunk and interior lighting, personal lighting devices, convenient, but highly visible devices for pedestrians, mood lighting devices, camping needs and so on.

A need is seen for a convenient bright to low light level lighting device that is easily adapted for all of the above uses and others without significant modification. A versatile lighting device that is useful in many different applications is presently believed unavailable commercially. The present invention is directed to providing a solution to this problem. A need is seen for a simple battery operated device that is portable and adaptable for personal safety or decorative applications with bright illumination as well as white or colored light. A single device that is versatile resolves the need for keeping a wide variety of illuminating devices on hand.

Some commercially available devices are not readily adaptable for many different possible needs, creating a void even though some such devices are at hand. For example, the common flashlight is used for many purposes, but it does not always serve the user in the best way. A flashlight might be used by pedestrians, but such devices provide focussed beams and may not always be seen by motorists. Specialty lights are available for bicycles and the like, but these too provide focussed beams not always visible to others. Also they may not be useful with other types of arrangements such as scooters, boats, bicycles or motorize vehicles and so on because of specific brackets provided for specific applications.

An illumination device according to an aspect of the present invention comprises a source of illumination and a solid elongated optical illumination transmitting element having a length defining a longitudinal axis between first and second ends, the element having a peripheral surface along the length between the ends, the element being coupled to the source such that the element conducts the illumination along the axis. A member is attached to a portion of the peripheral surface for causing the element to transmit illumination from the conducted illumination in an outward radial direction through the peripheral surface along the length between the ends. An electrical circuit illuminates the source of illumination.

Since the device is elongated and can be battery operated, it is portable and can be provided with colored light as well as steady state or flashing light as needed. The light by radiating outwardly from an elongated element provides broad radiation in different directions as compared to focussed beams provided by flashlights. This kind of device is readily seen at night from many directions and by providing a source of light of a given color and intensity it can be used for safety as well as decorative or mood purposes.

In one aspect, the member is arranged for providing enhanced reflection of the illumination in the radial direction. Preferably, the member is white. And more preferably, the member is a tape with an adhesive coating for adhering the member to the optical element.

In a further aspect, the element is optically transparent acrylic plastic and preferably is an optically transparent acrylic plastic rod having a given transverse geometric shape which in one aspect the rod is cylindrical and preferably the rod is circular cylindrical. More preferably, the rod has a half round shape in transverse section forming a semi-circular cylindrical peripheral surface and a planar peripheral surface on a side opposite the semi-circular cylindrical surface.

In a further aspect, an illumination reflecting member is attached to the planar surface and in a further aspect, the reflecting member is white tape.

In a further aspect, the element is a rod with a peripheral surface and the member is an illumination reflecting tape on a portion of the peripheral surface.

In a still further aspect, the device further includes a housing for securing the source, element and attached member and circuit thereto. Preferably, the housing has a window for permitting the transmission of the illumination in the outward radial direction.

In a further aspect the device includes attachment means for attaching the housing to an object and preferably, the attachment means is at least one strap.

In another aspect, the attachment means includes hook and loop fastening arrangements or an adhesive means for adheringly attaching the housing to the object.

In a still further aspect, the circuit includes means for causing the illumination to oscillate on and off.

In a further aspect, the element has at least one bore in each end arranged to receive the illumination source therein. Preferably, the illumination source is an LED (light emitting diode). Still other aspects are described in the following description.

### IN THE DRAWING

FIG. 1 is an isometric view of an illumination device according to an embodiment of the present invention;

FIG. 2 is an isometric exploded view of the device of the embodiment of FIG. 1;

FIG. 3 is an isometric view of the optical illumination element of the device of FIGS. 1 and 2;

FIG. 4 is a side elevation view of the device of FIG. 1;

FIG. 5 is a top plan view of the device of FIG. 1;

FIG. 6 is a bottom plan view of the device of FIG. 1;

FIG. 7 is a sectional elevation view of the embodiment of FIG. 5 taken at lines 7-7;

FIG. 8 is a side elevation view of a representative LED used in the device of FIG. 1;

FIG. 8a is a top plan view of the LED of FIG. 8;

FIG. 9 is a fragmented side elevation sectional view of the LED end portion of the light transmitting element of the embodiment of FIG. 1;

FIG. 10 is a top plan view of a printed circuit board assembly used in the device according to the embodiment of FIGS. 1 and 2;

FIGS. 11 and 12 are circuit diagrams useful with the devices of the embodiments of FIGS. 1 and 2; and

FIGS. 13a, 13b and 13c are end elevation views of different geometric shaped illumination transmitting elements according to the present invention wherein FIG. 13b is an end elevation view of the element of the embodiments of FIGS. 1 and 2 and wherein the FIG. 13c element is used with a single LED at each end and the elements of FIGS. 13a and 13b are used with dual LEDs at each end.

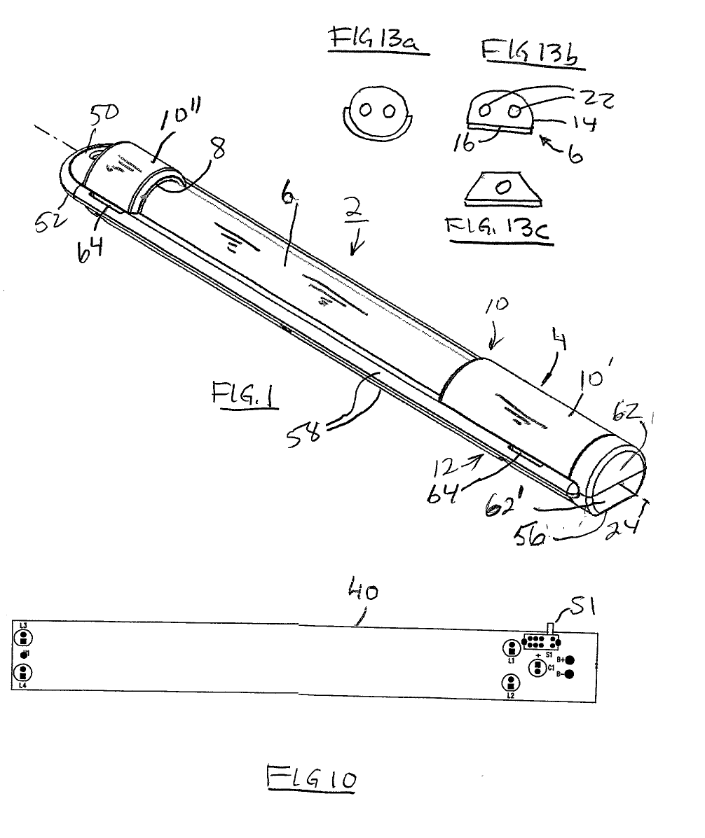

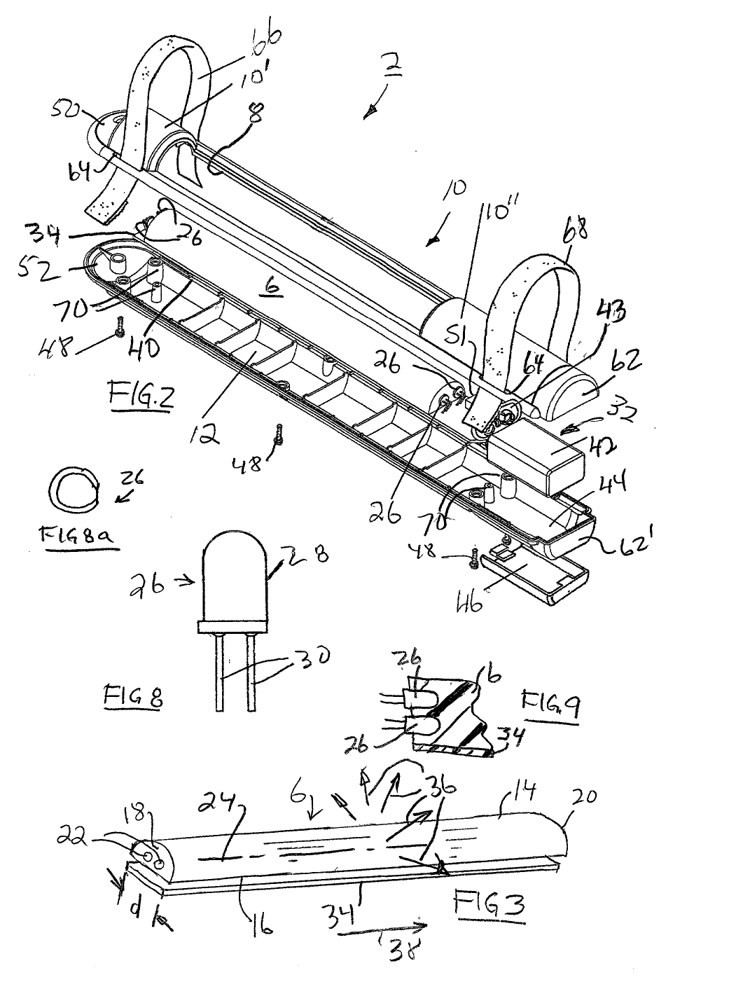

In FIG. 1, illumination device 2 comprises a housing 4 and an illumination transmitting element 6. The element 6 is radially exposed to the ambient atmosphere through window 8 of the housing. Window 8 is an opening with no cover. The housing 4 comprises two mating halves 10 and 12. The housing halves 10 and 12 are preferably injection molded thermoplastic material. The housing 4 is overall generally circular cylindrical in this embodiment but could be other geometric shapes as desired, e. g., square or rectangular in end view or polygon of any number of sides as desired.

In FIGS. 3 and 13b, element 6 preferably comprises a half round opticallly transparent acrylic plastic rod having a circular semi-cylindrical convex surface 14 on one half surface of the rod and a planar surface 16 on the opposite side of the rod. Preferably, the rod is eight inches long in one embodiment, but may have other lengths to suit a given need. The rod surface 14 has a one inch (25.4 mm) diameter so that the distance d represents the diameter. The element 6 has planar end surfaces 18 and 20 at opposite first and second ends.

A pair of like spaced circular cylindrical bores 22 are formed in each end surface 18 and 20 normal to the end surface. The bores in this embodiment are preferably about 0.5 inches (13 mm) apart and about 0.08 inches (2 mm) from the surfaces 14 and 16. The bores may be about 0.200 inches (5 mm) in diameter and about 0.356 inches (9 mm) deep. The bores should be smooth with no roughness so as to be optically clear into the element core from the bore surface to maximize light transmission therethrough. The bores 22 should be parallel to each other and to the longitudinal axis 24 of the element 6 and device 2.

A preferably white tape strip 34, FIG. 3, which may be opaque, is bonded to the flat surface 16 of the element 6. The tape strip 34 acts as a reflector, and scatters incident axially transmitted illumination radiation along the element longitudinal axis in the radial directions 36 from the element 6. The tape is made of paper and has one side coated with an adhesive. The other side is white and somewhat reflective. This side also is somewhat rough so as to scatter incident light such as the axial transmitted light in the element 6. The tape in one form is available as PF14 Flat Back Premium from Intertape Company. The strip may be other colors, but it is believed that white reflects and scatters the maximum amount of illumination radially. Normally, the substantially all of the Illumination from the LEDs is transmitted by the element axially in direction 38 parallel to axis 24. Relatively little radiation is emitted normal to the axis 24. However, the strip 34 reflects and scatters the photons radially out of the element through the convex peripheral surface 14 with a minimum of loss (illumination remaining axially trapped in the element 6).

Using what is referred to as Super Bright LEDs from Sunled Corporation, a relatively bright light is radiated outwardly in the radial directions 36 providing good illumination for a variety of purposes as will be explained below. The amount of light radiated is a function of both the surface area of the element 6, which due to its axial length, provides the desired amount of radiated light and the intensity of the LEDs. These are available at different intensity levels and colors as described below. The light is clear and bright and may be provided in different colors to suit a given application, e.g., red for warning, white for illuminations and other colors for decorative or mood lighting. Also, different colored LEDs may be provided coupled to a single element to provide different color hues not otherwise available in individual LEDs. Preferably, two LEDs at each element 6 end provides a bright light suitable for most purposes.

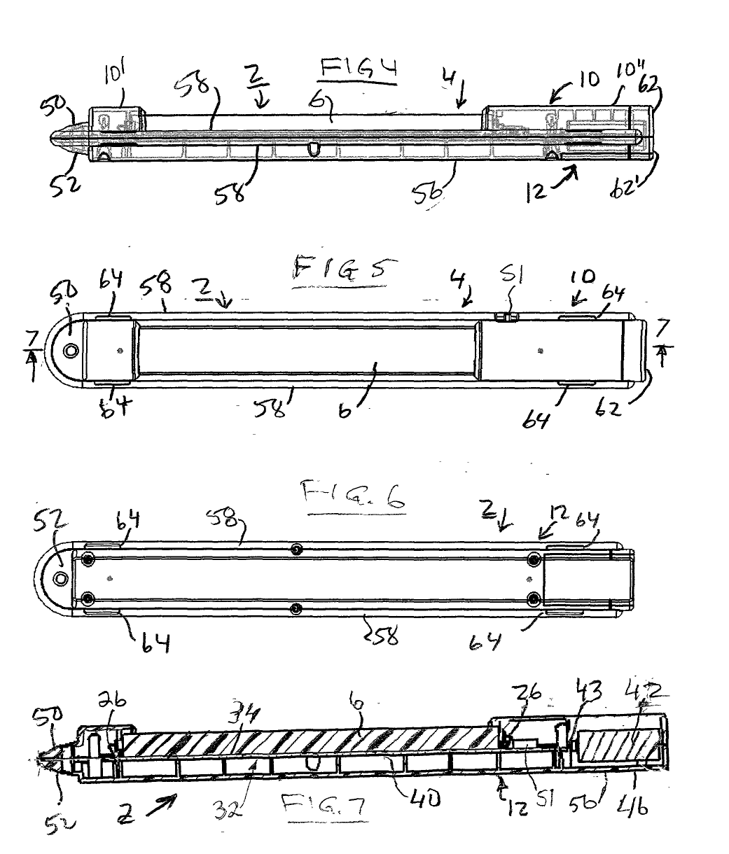

An LED (light emitting diode) 26 is inserted in each bore. The LED 26 has an illuminating portion 28 and a pair of electrical leads 30. The portion 28 is inserted into the corresponding bore 22 of the element 6, FIG. 3. The LEDs are commercially available, for example, from Sunled Corporation of Walnut, Calif. They preferably are 5 mm round with a flat on one side as shown in FIG. 8a.

They are available as Super Bright lamps with maximum ratings of a reverse voltage VR of about 5 volts, a forward current IF of about 30 mA, a forward peak current IFP1/10 duty cycle of 0.1 ms pulse width of 160 mA, power PO dissipation of 105 mW. The operating characteristics are typical forward voltage VF (IF=20 mA) of 3.5 volts, a forward max voltage VF of 4.0 volts and a reverse current (VR=5 volts) IR of 10 uA. They have a luminous intensity of 2200 to 3100 mcd.

The LEDs are available from Sunled Corporation under catalog designation LCW53WD color white. The emitting material is GaN. Other LEDs are available under Sunled catalog designations LMY53x yellow color with intensity mcd of 100-500 diffused to 700-2500 water clear, LCB53WD blue GaN material 1200-3000 mcd intensity water clear, LCB12WD blue GaN material 120-2100 mcd, LBG53WE green InGaN material water clear with mcd 2800 to 4500. Still other LEDs are available with other characteristics according to a given need.

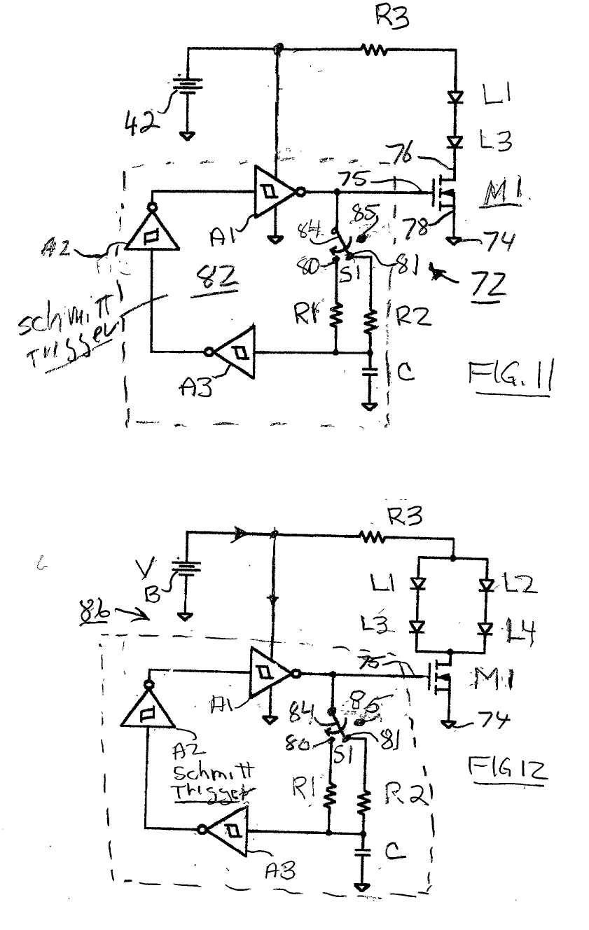

The device 2, FIG. 2, includes, in addition to the housing halves 10 and 12 and element 6, a printed circuit assembly 32 which includes a printed circuit board 40, FIG. 10. The board 40 includes the components of either of FIGS. 11 and 12. The element 6 with the strip 34 attached by bonding by an adhesive coating on one surface of the strip is attached to the printed circuit board 40 by clamping the element between the printed circuit board 40 and the upper housing half 10, FIG. 1. The board 40 and element 6 are clamped together by the housing 4. The strip 34 has a single side adhesive for attachment to the element 6. The surface of the strip 34 and adhesive coating together provide the optical qualities necessary to reflect the illumination in the radial directions 36, FIG. 3. The strip, as noted above, may be obtained from Intertape company.

The circuit assembly 32 includes all of the electrical components to operate the device 2. Such components will be described below in connection with the circuit diagrams of FIGS. 11 and 12.

The device 2, FIG. 2, also includes a conventional 9 volt battery 42. The battery 42 is connected to the circuitry by a conventional connector and strap arrangement 43. The lower housing half 12 has a compartment 44 for the battery and enclosed by a cover 46. The two housing halves 10 and 12 are attached by screws 48. The two halves together form a generally cylindrical housing. The bottom half 12 is generally frusto-semi-circular cylindrical with a flattened surface 56 for mounting on a flat surface. The top half 10 has semi-cylindrical portions 10′ and 10″ spaced by the window 8. The housing halves 10 and 12 have mating flanges 50 and 52, respectively at one housing end.

The upper and lower housing halves 10 and 12 also have mating peripheral flanges 58 which surround the housing 4 on three sides. The flanges 58 have mating slots 64. Two straps 66 and 68, FIG. 1, carry hook and loop fasteners, such as Velcro fasteners, and pass through and are attached to the housing 4 via the slots 64. The straps 66 and 68 attach the device 2 to bars and rods such as found on scooter and bicycle frames and so on, for example. The hook and loops enable one strap end to fasten to the other strap end in a known manner.

The housing halves also have stanchions 70, FIG. 2, for receiving the various screws 48. Overall, the housing 4 appears as an elongated wand with the illuminating element 6 exposed through the window 8. The window 8 may optionally be enclosed by a clear plastic cover (not shown). The battery 42 end of the housing 4 has flat end surfaces 62, 62′, FIGS. 1 and 2.

In FIG. 11, the operating circuit 72 comprises the 9 volt battery 42 having its positive terminal connected to series connected LEDs L1 and L3 through resistor R3. The LEDs are connected to ground via FET transistor M1 collector and emitter terminals 76 and 78. The junction between resistor R3 and the battery 42 is connected to operate inverting amplifier A1 of Schmitt trigger circuit 82 which provides an oscillating signal to the control electrode 75 of transistor M1. Circuit 82 comprises three series connected inverting amplifiers A1, A2 and A3 of an integrated circuit chip supplied as part number CD 40106 BCM of Motorola and available from distributors DigiKey or FAI. The output of the circuit 82 amplifier A1 is supplied to the common terminal connected to wiper 84 of switch S1 and to the control electrode of transistor M1. Switch S1 has three terminals 80, 81 and 85 which are selectively connected to the common terminal of wiper 84. Terminals 80 and 81 are respectively coupled to the input of amplifier A3 through respective resistors R1 and R2 and to ground through capacitor C. Terminal 85 is open to turn the circuit off.

Resistor R1 may have a value of 2 K ohms, resistor R2 may have a value of 200 K ohms, and resistor R3 may have a value of 36 ohms 1/4 watt. Capacitor C may have a value of 1 uF, 10 V min.

In operation, with the switch S1 in the position shown, resistor R2 is in circuit, the transistor M1 is conductive via the collector-emitter path lighting the LEDs L1 and L3 so as to appear to be a steady state continuous mode light. When the switch S1 is switched to place the resistor R1 in circuit, the transistor M1 remains conductive and the LEDs L1 and L3 light intermittently in a flashing mode. The LEDs are turned off when the wiper 84 is switched to terminal 85. The switch S1 is operated externally the housing 4, FIG. 1.

The circuit 86 of FIG. 12 is substantially identical to the circuit 82 of FIG. 11 and has the same value components as the circuit of FIG. 11 except for resistor R1 which has a value of about 75 ohms, and which components are connected in the same fashion. A further exception is that the circuit 86 has four LEDs L1, L2, L3 and L4 in circuit as compared to the two LEDs of the circuit 82. LED L1 and L3 are series connected as in the prior circuit, but that series connection is connected in parallel with the series connection of LEDs L2 and L4 in this circuit. This parallel network of LEDs, which all preferably have the same electrical characteristics and the same color or, in the alternative, different colors as desired, is connected between resistor R3 and the transistor M1 collector terminal. All other components of the two circuits are the same as well as their connections. The LED 1 and LED 2 are at one end of the element 6 and the LED 3 and LED 4 are at the other opposite end of the element 6. The circuit 86 is shown with the wiper 84 connected to resistor R2 in the steady state continuously lit mode of the LEDs. When switched to connect R1 in circuit, the LEDs flash on and off in the intermittent flashing mode. The frequency of the flashes may be set by using components of selected values in a known manner. Different component values may be provided in the circuit in parallel with switches (not shown) for varying the flashing frequency. Connecting switch S1 wiper 84 to terminal 85 shuts the LEDs off.

The light from the LEDs normally transmits axially in the optical element 6 of the devices with negligible transmission radially. The light impinges on the member 34 white or off white somewhat reflective surface and is scattered and reflected generally away from the optical axis 24 radially outwardly from the element 6 through the element outer surface. The light is scattered in about a 180° arc and provides bright illumination in such directions. Such non-focussed light is visible to a much greater degree than focussed light such as in flash lights or light devices that use parabolic reflectors and the like.

The straps 66, FIG. 2, permit the device 2 to be attached to scooters, bicycles, wheelchairs, a persons clothing such as belts and the like and numerous other objects about which the straps can be wrapped or to which Velcro type fasteners can be secured. For example, the straps can be attached to other hook and loop devices that are commercially available and easily attached to, e.g., with adhesives as provided on such hook and loop materials as commercially provided, many different objects such as clothing, automobile interiors, and trunk and hood interiors, pedestrian clothing, auto exteriors for roadside warning, marker lights for bulky items carried on vehicles at night, camping and directional indicators for help applications, dental, hospital and other locations for mood lighting, boating indicators, hazard warning lighting and so on. The element 6 may preferably be about eight inches long, but may be other lengths depending upon a given implementation. The light given off is bright and can be colorful for providing visibility and immediate recognition at night in many directions. While batteries are provided, the circuitry may also be connected to power adapter transformers if desired for more permanent installations. For example, the lights may be used as stair and side walk markers or lawn decorative lighting as desired, attached to trees or any other use where light is required. The devices 2 are flexible in utility and in colors employed, yet are inexpensive to operate and maintain while providing long life.

It will occur to one of ordinary skill that various modifications may be made to the disclosed embodiments which are given by way of illustration and not limitation as described above by way of example. It is intended that the scope of the invention is as defined by the appended claims.

What is claimed is:

1. An illumination device comprising:
a source of illumination;
a solid elongated optical illumination transmitting element having a length defining a longitudinal axis between first and second ends, the element having a peripheral surface along the length between said ends, the optical illumination transmitting element being coupled to the source such that the element conducts said illumination along the axis;
a member attached to a portion of the peripheral surface for causing the optical illumination transmitting element to transmit illumination from said conducted illumination in an outward radial direction through said peripheral surface along said length between said ends; and
an electrical circuit for illuminating said source of illumination.

2. The device of claim 1 wherein said member is arranged for providing enhanced reflection of said illumination in the radial direction.

3. The device of claim 2 wherein the member is white.

4. The device of claim 2 wherein the member is a tape with an adhesive coating for adhering the member to the optical illumination transmitting element.

5. The device of claim 1 wherein the optical illumination transmitting element is optically transparent acrylic plastic. material

6. The device of claim 1 wherein the optical illumination transmitting element is optically transparent acrylic plastic rod having a given transverse geometric shape.

7. The device of claim 6 wherein the rod is cylindrical.

8. The device of claim 7 wherein the rod is circular cylindrical.

9. The device of claim 6 wherein the rod has a half round shape in transverse section forming a semi-circular cylindrical peripheral surface and a planar peripheral surface on a side opposite the semi-circular cylindrical surface.

10. The device of claim 9 including an illumination reflecting member attached to the planar surface.

11. The device of claim 10 wherein the reflecting member is opaque white tape.

12. The device of claim 1 wherein the optical illumination transmitting element is a rod with a peripheral surface and the member is an illumination reflecting tape on a portion of said peripheral surface.

13. The device of claim 1 further including a housing for securing the source, element and attached member and circuit thereto.

14. The device of claim 13 wherein the housing has a window for permitting the transmission of said illumination in the outward radial direction.

15. The device of claim 13 including attachment means for attaching the housing to an object.

16. The device of claim 15 wherein the attachment means is at least one strap.

17. The device of claim 15 wherein the attachment means includes hook and loop fastening arrangements.

18. The device of claim 15 wherein the attachment means includes adhesive means for adheringly attaching the housing to said object.

19. The device of claim 1 wherein the circuit includes means for causing said illumination to oscillate on and off.

20. The device of claim 6 wherein the optical illumination transmitting element has at least one bore in each end arranged to receive the illumination source therein.

21. The device of claim 1 wherein the illumination source is an LED (light emitting diode).

22. The device of claim 20 wherein the optical illumination transmitting element has two spaced bores in an axial direction of said axis in each end of the optical illumination transmitting element and the source comprises an LED in each bore.

23. The device of claim 22 wherein the LED in each bore has the same color.

24. The device of claim 22 wherein at least two of the LEDs have different colors.

25. The device of claim 22 including means for selecting one of said colors or both said colors in alternating fashion.

26. An illumination device comprising:
a housing having a window;
a source of illumination;
a solid elongated optical illumination transmitting acrylic element in optical communication with the window and having a length defining a longitudinal axis between first and second ends, the element having a planar peripheral surface portion and a semi-circular cylindrical surface portion opposite the planar surface along said length between said ends, the element being coupled to the source at at least one end such that the element conducts said illumination along the axis;
a member attached to a portion of the peripheral surface for causing the optical illumination transmitting element to transmit illumination from said conducted illumination in an outward radial direction relative to said axis through said peripheral surface and window along said length between said ends; and
an electrical circuit for illuminating said source of illumination.

27. The device of claim 26 including means for attaching the device to an object.

28. The device of claim 27 wherein said means for attaching includes at least one strap.

29. The device of claim 26 wherein the source of illumination is at least one LED.

30. The device of claim 26 wherein the member is an illumination reflecting material for scattering the conducted illumination in the outward radial direction.
